(19) United States
(12) Patent Application Publication
(10) Pub. No.: US 2005/0228756 A1
(43) Pub. Date: Oct. 13, 2005

(54) Monetary claim settlement method

(76) Inventors: Bruce B. Bealke, Valley Village, CA (US); Lawrence W. Shea II, La Jolla, CA (US)

Correspondence Address: ROBERT R. THORNTON, 3264 MEADOWLARK LANE, CARLSBAD, CA, 92008-2024, US

(21) Appl. No.: 10/820,194

(22) Filed: Apr. 6, 2004

(51) Int. Cl. G06F 17/60

(52) U.S. Cl. 705/80; 705/1

(57) ABSTRACT

The present invention relates to the satisfaction of an agreed to monetary settlement of a claim and provides claimants with the ability to electronically execute claims settlements, including releases, and for the issuance to the claimant, preferably electronically, of redeemable vouchers for at least a portion of the settlement amount and for the immediate transfer of funds for any remainder of the settlement amount to the claimant. In the presently preferred embodiment of the invention, a settlement processing entity is utilized to receive the proposed settlement terms and their acceptance, electronically receive the execution of any release by the claimant, and to initiate the electronic transfer of at least one voucher having a stated redemption value and, if required, settlement funds, the total of which exceeds the settlement amount, to the claimant after acceptance and electronic execution by the claimant of any release. In the preferred embodiment of the invention, the settlement processing entity pays a vendor obligated to redeem the voucher an amount less than the voucher's stated redemption value for the voucher. In further embodiment of the invention, the settlement processing entity receives a total monetary payment from the funding entity in satisfaction of the funding obligation which is less than the monetary settlement amount.

### FIELD OF INVENTION

This invention generally relates to computerized systems for the electronic execution of settlements of claims according to the terms of electronically executed settlement documentation.

### BACKGROUND OF THE INVENTION

The property/casualty insurance industry currently faces at least one hundred million claims every year. When combined with other large entities that self-insure, it is estimated that the number of “insurance” type claims currently exceeds two hundred million per year nationally. Property/casualty claims normally settle quickly. There is typically a delay in sending settlement funds to claimants pending receipt by the party funding the settlement or its representative of the executed settlement documents, normally including a fully executed Release. The current process for executing the Release and disbursing a settlement check may take from ten to twenty-one days. Since claims typically are filed by individuals and, with the exception of worker's compensation, health insurance and similar matters, are not recurring, it is not cost effective for insurers to maintain a historical database with wiring instructions pertaining to individual claimants. In addition, the cost to the entity actually making the payment by issuing the physical check currently is approximately twenty-five to fifty dollars per check.

### SUMMARY OF THE INVENTION

According to the present invention, a method for implementing satisfaction of a settlement of a claim between a claimant and another settling party on agreed to settlement on terms including a monetary amount comprises a settlement processing entity receiving the settlement terms and their acceptance by the claimant and settling party, including receiving an executed release by claimant of the other settling party and a payment of at least a portion of the monetary amount to be paid to the claimant on behalf of the other party, the settlement processing entity initiating the transfer to the claimant of at least one voucher having a stated redemption value and, if required, an electronic transfer of settlement funds in an amount such that the total of the voucher redemption value and funds transferred exceeds said monetary amount, and the settlement processing entity paying a vendor obligated to redeem the voucher an amount less than the voucher's stated redemption value for the voucher. In a presently preferred embodiment, the payment of at least a portion of the monetary amount to be paid to the claimant on behalf of the other party is in an amount which is less than the monetary amount, although, alternatively, the payment of at least a portion of the monetary amount is in an amount which is the monetary amount, and thereafter, a portion thereof is returned to its payor by the settlement processing entity. In a further embodiment, the payment is received by the settlement processing entity after the settlement processing entity makes any required electronic transfer of funds to the claimant, and, in any embodiment, if desired, the voucher is electronically transmitted to the claimant.

By way of further illustration, in a monetary dispute between a first party and a second party, as to which the parties agree to a specific monetary settlement, the first party communicates terms of and participants in the monetary settlement to a third party, the third party assigns a unique identifying designator to the settlement terms and participants, the third party makes the settlement terms available for access by the second party over an electronic network by use of the designator and the designator is communicated to the second party, the second party uses the designator to electronically access the settlement terms, the second party electronically transmits either a settlement terms acceptance communication or a settlement terms refusal communication to the third party, and the third party, if the communication is a refusal communication, notifies the first party of the refusal, and, if the communication is an acceptance communication, provides the second party with the option of consummating the settlement by receiving a lump sum payment of the specific amount of the settlement or consummating the settlement by receiving vouchers for at least a portion of the settlement amount, the vouchers having a face value which, when combined with any lump sum payment made in consummating the settlement, exceeds the settlement amount.

### BRIEF DESCRIPTION OF THE DRAWING

FIG. 1 is a block diagram illustrating the overall steps in the practice of the method of the present invention in satisfying a claim between a first party against a second party, in which the terms and acceptance of the settlement are communicated through a third party.

### DETAILED DESCRIPTION OF THE INVENTION

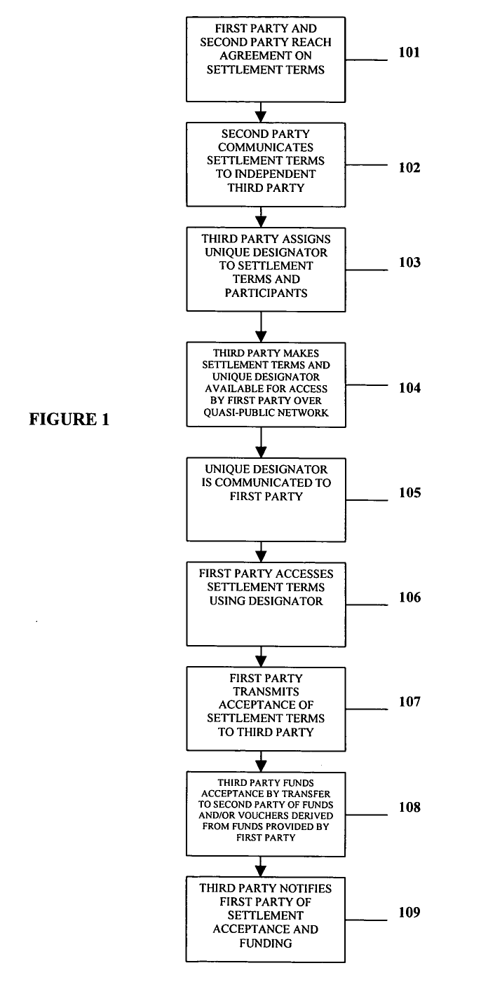

Referring now to FIG. 1, a method for funding a resolution of a claim is shown in block diagram form illustrating the steps of the method. Although certain of the embodiment descriptions which follow employ an insurance claim settlement method for purposes of illustration, those skilled in the art will understand that the scope of the present invention is not limited thereto in its broadest aspects. Accordingly, the use of terms such as “claimant,” “claimant's attorney”, “plaintiff's or plaintiffs' attorney,” “insurer,” “carrier,” “claims representative” and/or “adjuster” refer to the participants in a settlement of a claim for monetary damages, as to which the utilization of the methods of the present invention are particularly advantageous with respect to the methods of the prior art, and are to be understood to be for illustrative purposes, rather than being terms of limitation, unless otherwise indicated.

In FIG. 1, it is assumed that an event occurs which results in a first party, in the position of a claimant or a claimant's representative, asserting a claim and a second party, in the position of an entity against which the claim is asserted or its representative. In the first step, illustrated in Block 101, the first party and the second party reach an agreement as to a proposed monetary settlement of the claim, including a release thereof, at least as to the second party. In the second step, illustrated in Block 102, the second party communicates the settlement terms to a third party, preferably but not necessarily not a real party in interest to the dispute, ie., an independent third party. In the third step, illustrated in Block 103, the third party assigns a unique designator to the settlement terms and participants. In the fourth step, illustrated in Block 104, the third party makes the settlement terms and the unique designator available to the first party as, for example by access through a quasi-public network such as the Internet, by use by the first party of the unique designator assigned by the third party to the settlement terms.

In the fifth step, illustrated in Block 105, the unique designator is communicated to the first party. Such communication is made by or through either the third party or the second party, and preferably is made by a method with at least some security, such as a direct telephone call, an encrypted email message, a facsimile transmission or other direct written delivery, to avoid ready access to the terms by others not involved in the dispute. For example, the third party may provide the designator to the second party, who, in turn, telephonically transmits it to the second party. In the sixth step, illustrated in Block 106, the first party accesses the settlement terms electronically by using ,the designator, so that the security of the terms is preserved, as access to the terms is denied to those not possessing the unique designator information. Preferably after accessing the settlement terms, the first party is provided with an option to receive at least a portion of the monetary settlement in the form of vouchers which can be redeemed for goods or services, although, if desired, this option can be provided to the first party at a prior time so as to be reflected in the settlement terms already.

In the seventh step, illustrated in Block 107, the first party, having considered the settlement terms accessed by using the unique designator, electronically transmits an acceptance of the terms to the third party, preferably through the same network by which access was achieved. This acceptance includes the acknowledgment of execution of a release of the claim at least as to the second party, and, if appropriate, includes the exercise of the option to receive at least a portion of the monetary settlement in the form of the vouchers. In the eighth step, illustrated in Block 108, the third party, after receiving the acceptance, funds the settlement by the transfer of funds from a source of funds designated by the second party and any required vouchers to or for the benefit of the first party. In the ninth step, illustrated in Blaock 109, the third party notifies the second party of acceptance of the settlement, the release of the claim, and the funding of the settlement.

In the preferred embodiment, the first party, for example, a claimant, accepts at least a portion of the monetary settlement amount in the form of vouchers having a face value which, when combined with the amount of the funds actually transferred to the first party, exceeds the amount of the monetary settlement previously agreed upon by the first and second parties. For example, assume that the monetary settlement agreed upon by the first and second parties is $10,000.00. The third party, acting as a settlement processing entity, and which preferably is independent of the other parties, and the first party agree that the first party will receive $8,000.00 in cash and receive vouchers having a face redemption value of $3,000.00 in lieu of the remaining $2,000.00 cash portion of the $10,000.00 settlement, as settlement in full, thus providing the first party, in the position of claimant, with the equivalent of $11,000.00, rather than the $10,000.00 amount agreed upon by the first and second parties.

In the presently preferred embodiment of the invention, the third party acquires vouchers from vendors of goods and/or services at a discount from the face amount of the vouchers, for example, paying a vendor $1,250.00 for vouchers which the vendor will redeem for a value of $3,000.00.

In the presently preferred embodiment of the invention, in order to induce the second party (such as an insurer) to use the services of the third party in the settlement satisfaction process, the third party (settlement processing party) agrees to be paid only $9,500.00 by the second party, rather than the $10,000.00 settlement amount, and no service charge for the services rendered by the third party, thus saving the second party $500.00 based on the agreed settlement amount. In this example, the third party has received $9,500.00 from the first party, only $8,000.00 of which has been paid to the second party and only $1,250.00 of which has been paid to the vendor, leaving the third party with a gross profit of $250.00 on the transaction. Obviously, this is only exemplary, and is not intended as setting any limitations of the relative contributions of the parties and the vendors to the overall financial resolution of the dispute.

The following steps are a detailed explanation of the practice of the present invention by way of setting out the steps undertaken by the various participants for a specific example of a settlement satisfaction utilizing the present invention:

An insurance claim is undisputed and the claimant is not represented by counsel. The claim is processed by a claims representative (“claims rep”) of the insurance carrier and a total dollar amount for the loss is determined (the “loss amount”). The claims rep and the claimant agree upon payment of the loss amount as satisfaction in full of the claim, and that claimant will execute a release in return for the payment of the loss amount.

The claims rep enters the total dollar value of the loss amount into the carrier's computerized claims system and submits the claim information to Doe Company's data system (“the System”) by computer over electronic network, such as the quasi-public Internet. Doe Company is acting as a settlement processing entity according to the present invention. The System uploads relevant claim data as to the claimant from the carrier's data system and assigns a claim identification number (“CIN”) to the claim. The CIN is downloaded into the carrier's computerized claims system and the claims rep is notified of the CIN and a URL for accessing the claim on the System web site.

Upon the CIN being downloaded into the carrier's system, funds in an amount equal to the loss amount are wire transferred by the carrier from an account to a trust account maintained by the System. The claims rep notifies the claimant of the availability of the loss amount from the System, and provides claimant with the CIN, the URL for the System Web site, and a toll free telephone number for telephonic communication with representatives of the System.

If the claimant does not have access to, or does not want to use the Internet to obtain the settlement funds, the claimant calls the toll free number and, utilizing the CIN, requests a check for the value of the settlement offered by the carrier.
a. The System notifies the carrier that the claimant has requested a check.
b. The System sends a check to the claimant as requested.
c. The CIN is deactivated by the System.

If the claimant wants to use the System to access the settlement funds, the claimant utilizes the URL and the quasi-public network to access the System web site. Upon accessing the System web site, the claimant submits the following information:
a. The CIN
b. Claim number
c. Name of insured
d. Carrier
e. Date of loss
f. Zip code

The System uploads and verifies the matching criteria. If the entire criteria match the corresponding information downloaded from the carrier's computerized claims system, the System allows the claimant to enter the System web site. If any of the required criteria do not match, the System generates an error message and all activity on for that CIN is suspended. The System notifies a System administrator about the error and the administrator works with the claimant to clear the error message. Once the error is cleared, the claimant proceeds.

Upon gaining authorized entry to the System, the claimant is asked to set a personal claim identification number (“PCIN”) for security purposes. After activating the PCIN, the System provides the claimant with information regarding ACH transfers, wire transfers and Vouchers that are available from System, affiliated vendors, and other businesses. The system allows the claimant to test, save, edit, and accept various scenarios regarding disbursal of the settlement funds. Claimant may choose to receive funds in one or more of the following ways:
a. Checks
b. ACH transfers
c. Wire transfers
d. Vouchers
e. Combinations of any or all of the above

For each scenario claimant accepts, the system provides access to a proposed release of the carrier in a PDF format. If claimant accepts the terms of the release, claimant activates a link to electronically sign the release and electronically signs it. If the claimant does not agree to the terms of the release, the claimant activates a “Cancel” link, and the System displays a screen confirming that the claimant has cancelled the particular proposed settlement and asks if the claimant would like to choose another scenario.

If the claimant does not want to choose another scenario, the claimant is logged off the system and may return at a later time. If the claimant wants to choose another scenario, the claimant is returned to the main screen and proceeds as before to investigate other scenarios.

If the claimant accepts the Release, the system will ask the claimant to state how the claimant wants the settlement funds disbursed, with respect to the following options:
a. Check
b. ACH transfer
c. Wire transfer
d. Voucher
e. Combinations of any or all of the above
   If the claimant wants all of the funds via ACH or wire transfer, the claimant submits the following information to the System for each wire by electronically completing an appropriate form provided by the System:
a. Tax I.D. or SSN(s)
b. Bank Name(s)
c. Bank Account Number(s)
d. Bank Routing Number(s) (ABA Numbers)
e. Account Name(s)

If the claimant wants all of the settlement funds disbursed via Voucher(s), the claimant submits to the System the number of Vouchers requested and the following information by electronically completing an appropriate form provided by the System:
a. Amount of each Voucher
b. Voucher delivery method(s) (e-mail, regular mail, store credit, etc.)

If the claimant wants the funds via a combination of ACH or wire transfers and Vouchers, the claimant submits the following information to the System for each transfer by electronically completing an appropriate form provided by the System:
a. Amount(s) to be disbursed by wire:
   i. Tax I.D. or SSN
   ii. Bank Name
   iii. Bank Account Number
   iv. Bank Routing Number (ABA Number)
   v. Account Name
b. Amount to be disbursed by Voucher(s):
   i. Number of Vouchers
   ii. Amount of each Voucher
   iii. Voucher delivery method

For ACH or wire transfer, the System:
a. Transfer funds from the carrier's account to a System trust account held for the benefit of the claimant, if not already transferred
b. Wires the funds to the account designated by the claimant
c. Sends confirmation to the claimant and the claims rep that the funds have been transferred

For all Vouchers, the System:
a. Delivers the Voucher(s) in the method specified by the claimant.
b. Sends confirmation to the claimant and the vendor(s) issuing the Voucher(s) that a Voucher has been issued, together with the amount of the Voucher

If Claimant decides to discontinue the settlement process, Claimant requests the System to terminate the connection.
a. The System asks Claimant to confirm by clicking “Terminate.”
b. If the claimant confirms the request, the System terminates access to the System and notifies the claims rep that the settlement has been aborted and returns any funds already transferred to the carrier's account.

Vendors agree to provide Vouchers for goods or services to System at an agreed upon discount from the face value of the Vouchers and all bank routing information necessary for the system to facilitate the transfer of funds held by System for the benefit of the claimant for payment to the vendors for the Vouchers at the discounted prices. When the claimant notifies the System of the acceptance of a settlement involving issuance of a Voucher, the System wires the funds from System trust account to the vendor as payment for the Voucher.

The System tracks all payments and/or Vouchers sent to the claimant and notifies the claimant when all funds and Vouchers due the claimant have been disbursed. When the claimant no longer has any funds held in trust by the System, the System deactivates the PCIN and closes the Claimant's account.

As will be apparent to those skilled in the art, the scope of the invention is not to be understood to be limited to the specific examples set out herein by way of explanation, but rather only by the claims hereof, as will be understood by those skilled in the art. Consequently, the presently preferred embodiments of the invention have been set forth herein in detail for illustrative purposes only, and it will be apparent to those skilled in the art that variations and modifications thereof, including the rearrangement, addition and/or elimination of steps, lie within the scope of the present invention, which is not limited to the specific sequences of the steps of the specific embodiments illustrated or described herein, but only by the scope of the following claims.

1. A method for implementing satisfaction of a settlement of a claim between a claimant and another settling party on agreed to settlement on terms including a monetary amount, comprising:
a settlement processing entity receiving the settlement terms and their acceptance by the claimant and settling party, including receiving an executed release by claimant of the other settling party and a payment of at least a portion of the monetary amount to be paid to the claimant on behalf of the other party;
the settlement processing entity initiating the transfer to the claimant of at least one voucher having a stated redemption value and, if required, an electronic transfer of settlement funds in an amount such that the total of the voucher redemption value and funds transferred exceeds said monetary amount; and
the settlement processing entity paying a vendor obligated to redeem the voucher an amount less than the voucher's stated redemption value for the voucher.

2. The method of claim 1 and in which the payment of at least a portion of the monetary amount to be paid to the claimant on behalf of the other party is in an amount which is less than the monetary amount.

3. The method of claim 1 and in which the payment of at least a portion of the monetary amount is in an amount which is the monetary amount, and thereafter, a portion thereof is returned to its payor by the settlement processing entity.

4. The method of either claim 2 or claim 3, and in which the payment is received by the settlement processing entity after the settlement processing entity makes any required electronic transfer of funds to the claimant.

5. The method of any one of claim 1, claim 2, claim 3 or claim 4, and in which the voucher is electronically transmitted to the claimant.

6. A method for implementing satisfaction of a settlement of a monetary claim agreed to by a first party and a second party comprising:
(a) the second party providing a third party with details of the monetary settlement and a source for funding the monetary settlement;
(b) the third party assigning a claim settlement identification number to the settlement details;
(c) the third party communicating with the first party to provide the first party with the claim identification number and the option to either receive the agreed monetary settlement in full or to receive at least a part of the monetary settlement in the form of vouchers which can be redeemed for goods and/or services;
(d) the first party electing either to receive the agreed monetary settlement in full or to receive at least a part of the monetary settlement in the form of vouchers and informing the third party of the election and if vouchers are elected, the portion of the monetary settlement to be paid in vouchers; and
(e) the third party withdrawing funds from the funding source and paying the monetary settlement by transmitting vouchers to the first party and/or transferring funds to the first party, in accordance with the election made by the first party, directly to the first party and/or to an account for the benefit of the first party, as directed by the first party.

7. The method of claim 6, and in which the third party provides the first party with vouchers which, when combined with the amount, if any, of the funds transferred to the first party from the source of funding, exceed the full amount of the monetary settlement.

8. The method of claim 7, and in which the funds withdrawn by the third party from the funding source are less than the funds transferred to the first party by an amount agreed upon by the first and second parties as a function of the amount of the vouchers.

9. The method of claim 7, and in which the third party purchases the vouchers from the suppliers of the goods and/or services at a discount from the face value of the vouchers.

10. The method of claim 8, and in which the third party purchases the vouchers from the suppliers of the goods and/or services at a discount from the face value of the vouchers.

11. The method of any one of claims 7, 8, 9 or 10 and in which the third party provides a network site through which any vouchers can be redeemed for goods or services, and in which the third party provides the first party with an ability to access to the network site.

12. A method for implementing satisfaction of an insurance claim in which a total dollar amount for the loss is agreed to be paid as satisfaction in full of the claim in return for the execution a release comprising the steps of:
a claims representative of the carrier submitting the claim information to a settlement processing entity data system by computer over an electronic network;
the system assigning a claim identification number (“CIN”) to the claim;
the CIN being downloaded into the carrier's computerized claims system;
the claims representative being notified of the CIN and a URL for accessing the claim on the system;
funds in an amount equal to the loss amount being wire transferred by the carrier from an account to a trust account maintained by the system;
the claims rep notifying the claimant of the availability of the loss payment in full from the System, and providing claimant with the CIN and the URL for the system web site;
the claimant utilizing the URL and the quasi-public network to access the system web site and submit the following information as matching criteria:
a. The CIN
b. Claim number
c. Name of insured
d. Carrier
e. Date of loss
f. Zip code;
the system uploading and verifying the matching criteria, then allowing the claimant to enter the system web site;
the System providing the claimant with information regarding ACH transfers, wire transfers and vouchers that are available from System, affiliated vendors, and other businesses and permitting the claimant to choose to receive funds in one or more of the following ways:
a. Checks
b. ACH transfers
c. Wire transfers
d. Vouchers
e. Combinations of any or all of the above;
and providing the claimant with a form of a release for electronic execution,
the claimant executing the release; and
the system disbursing the settlement funds to the claimant in accordance with the options selected by the claimant.

13. The method of claim 12, and in which the vendors agree to provide the vouchers for goods or services to the system at an agreed upon discount from the face value of the Vouchers and all bank routing information necessary for the system to facilitate the transfer of funds held by system for the benefit of the claimant for payment to the vendors for the vouchers at the discounted prices, and, when the system transferring the funds from system trust account to the vendor by wire as payment for voucher issued to the claimant.

14. The method of either claim 12 or claim 13, and including the steps of the system tracking all payments and/or vouchers sent to the claimant, and the system notifying the claimant electronically when all funds and vouchers due the claimant have been disbursed.

15. The method of any of claims 12, 13 or 14, and including the step, when the claimant no longer has any funds held in trust by the system, of the system deactivating the PCIN and closing the claimant's system account.
